(19) United States
(12) Patent Application Publication
(10) Pub. No.: US 2016/0010466 A1
(43) Pub. Date: Jan. 14, 2016

(54) GAS TURBINE ENGINE COMPONENT WITH TWISTED INTERNAL CHANNEL

(71) Applicant: UNITED TECHNOLOGIES CORPORATION, Hartford, CT (US)

(72) Inventor: Scott Lamson, Menands, NY (US)

(21) Appl. No.: 14/769,802

(22) PCT Filed: Feb. 21, 2014
(86) PCT No.: PCT/US2014/017661

§ 371 Date: Aug. 22, 2015

Related U.S. Application Data
(60) Provisional application No. 61/790,212, filed on Mar. 15, 2013.

(51) Int. Cl. F01D 5/18; F02C 7/12; F01D 25/24; F01D 9/04; F01D 25/14

(52) U.S. Cl. CPC F01D 5/187; F01D 9/041; F01D 25/14; F01D 25/24; F02C 7/12; F05D 2220/32; F05D 2240/35; F05D 2260/221

(57) ABSTRACT

A gas turbine engine component includes a component body that defines an internal micro-channel that extends in a lengthwise direction along a reference line. The internal micro-channel extends between a first reference position along the reference line and a second reference position along the reference line. The internal micro-channel twists at least 180 with respect to the reference line between the first reference position and the second reference position.

### BACKGROUND

This disclosure relates to cooling in gas turbine engine components.

Gas turbine engines typically include a compressor section, a combustor section and a turbine section. In general, during operation, air is pressurized in the compressor section and is mixed with fuel and burned in the combustor section to generate hot combustion gases. The hot combustion gases flow through the turbine section, which extracts energy from the hot combustion gases to power the compressor section and other gas turbine engine loads.

Due to exposure to hot combustion gases, numerous components of a gas turbine engine may include cooling schemes that circulate airflow to cool the component during engine operation. Thermal energy is transferred from the component to the airflow as the airflow circulates through the cooling scheme to cool the component.

### SUMMARY

A gas turbine engine component according to an example of the present disclosure includes a component body defining an internal micro-channel that extends in a lengthwise direction along a reference line. The internal micro-channel extends between a first reference position along the reference line and a second reference position along the reference line. The internal micro-channel twists at least 180° with respect to the reference line between the first reference position and the second reference position.

In a further embodiment of any of the foregoing embodiments, the internal micro-channel twists at least 360° with respect to the reference line between the first reference position and the second reference position.

In a further embodiment of any of the foregoing embodiments, the internal micro-channel twists multiple full revolutions with respect to the reference line.

A further embodiment of any of the foregoing embodiments includes at least one additional internal micro-channel also twisting at least 180° with respect to the reference line between the first reference position and the second reference position.

A further embodiment of any of the foregoing embodiments includes at least one additional internal micro-channel that is symmetrically arranged to the internal micro-channel with respect to the reference line.

In a further embodiment of any of the foregoing embodiments, the internal micro-channel is helical.

A further embodiment of any of the foregoing embodiments includes a plurality of additional internal micro-channels that also twist with respect to the reference line between the first reference position and the second reference position.

In a further embodiment of any of the foregoing embodiments, a cross-section of the internal micro-channel taken between the first reference position and the second reference position is elliptical.

In a further embodiment of any of the foregoing embodiments, a cross-section of the internal micro-channel taken between the first reference position and the second reference position is semi-circular.

In a further embodiment of any of the foregoing embodiments, the internal micro-channel has a maximum dimension in a cross-section taken perpendicular to the reference line of less than 0.635 millimeters.

In a further embodiment of any of the foregoing embodiments, the component body is metallic.

A gas turbine engine component according to an example of the present disclosure includes a component body defining an internal channel that extends in a lengthwise direction along a reference line. The internal channel extends between a first reference position along the reference line and a second reference position along the reference line. The internal channel twists, by a twist amount in degrees, with respect to the reference line between the first reference position and the second reference position. The internal channel has a maximum dimension in a cross-section taken perpendicular to the reference line. The twist amount and the maximum dimension produce a swirl of a flow of a cooling fluid through the internal channel with a swirl vector that is parallel to the reference line.

In a further embodiment of any of the foregoing embodiments, the twist amount is at least 360° and the maximum dimension is less than 0.635 millimeters.

In a further embodiment of any of the foregoing embodiments, the twist amount is greater than 360° and the maximum dimension is less than 0.635 millimeters.

In a further embodiment of any of the foregoing embodiments, the cross-section is semi-circular or elliptical.

A method of managing cooling in a gas turbine engine component according to an example of the present disclosure includes providing a flow of a cooling fluid through an internal micro-channel of a component body, the internal micro-channel extending in a lengthwise direction along a reference line, and inducing a swirl of a flow of a cooling fluid through the internal micro-channel with a swirl vector that is parallel to the reference line.

A further embodiment of any of the foregoing embodiments includes inducing the swirl using:

a. a twisting of the internal micro-channel of at least 360° with respect to the reference line between a first reference position along the reference line and a second reference position along the reference line, and

b. a maximum dimension of less than 0.635 millimeters in a cross-section taken perpendicular to the reference line.

A further embodiment of any of the foregoing embodiments includes selecting the twisting of the internal micro-channel of at least 360° with respect to the reference line and selecting the maximum dimension of less than 0.635 millimeters to increase a heat transfer coefficient of the internal micro-channel.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 illustrates an example gas turbine engine.

FIG. 2 illustrates an example of a gas turbine engine component.

FIG. 3 illustrates an isolated view of an internal micro-channel of a gas turbine engine component.

FIG. 4 illustrates a sectioned view of the channel of FIG. 3.

FIG. 5 schematically illustrates a swirl vector that is parallel to a reference line.

FIG. 6 illustrates another example internal micro-channel of a gas turbine engine component.

FIG. 7 illustrates a sectioned view of the channel of FIG. 6.

FIG. 8 illustrates an example of a plurality of internal micro-channels that twist around a reference line.

FIG. 9 illustrates a method of managing cooling in a gas turbine engine component.

### DETAILED DESCRIPTION

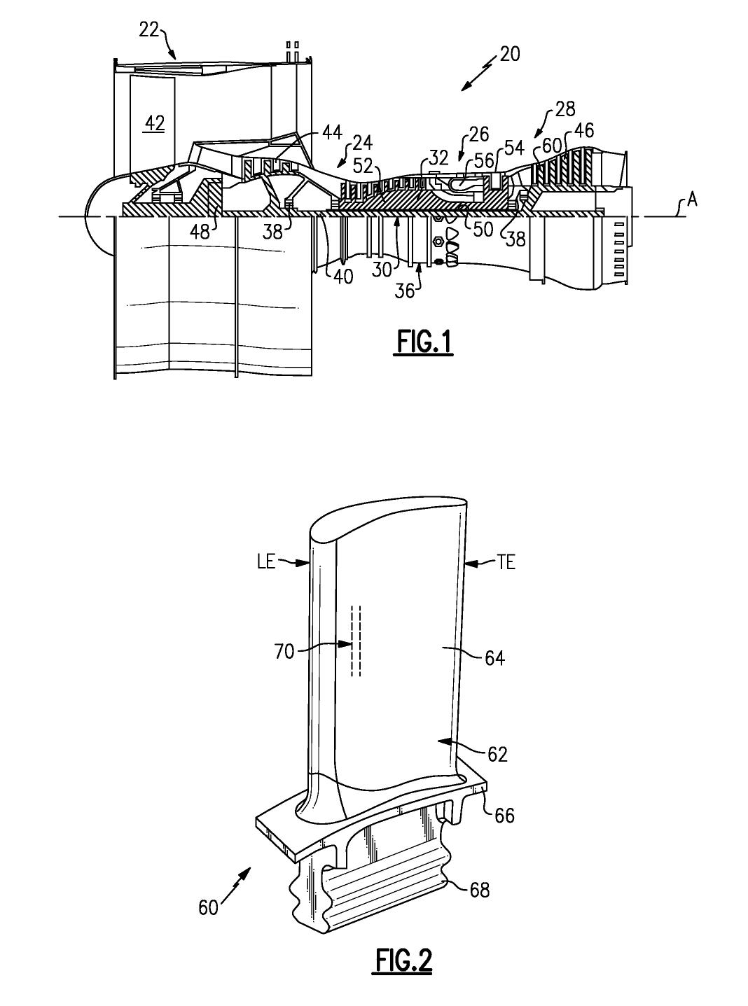

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flowpath while the compressor section 24 drives air along a core flowpath for compression and communication into the combustor section 26 then expansion through the turbine section 28. Although depicted as a turbofan gas turbine engine in the disclosed non-limiting embodiment, it should be understood that the concepts described herein are not limited to use with turbofans and the teachings may be applied to other types of turbine engines, including single spool architectures, three-spool architectures and ground-based turbines.

The engine 20 generally includes a first spool 30 and a second spool 32 mounted for rotation about an engine central axis A relative to an engine static structure 36 via several bearing systems 38. It should be understood that various bearing systems 38 at various locations may alternatively or additionally be provided.

The first spool 30 generally includes a first shaft 40 that interconnects a fan 42, a first compressor 44 and a first turbine 46. The first shaft 40 is connected to the fan 42 through a gear assembly of a fan drive gear system 48 to drive the fan 42 at a lower speed than the first spool 30. The second spool 32 includes a second shaft 50 that interconnects a second compressor 52 and second turbine 54. The first spool 30 runs at a relatively lower pressure than the second spool 32. It is to be understood that “low pressure” and “high pressure” or variations thereof as used herein are relative terms indicating that the high pressure is greater than the low pressure. An annular combustor 56 is arranged between the second compressor 52 and the second turbine 54. The first shaft 40 and the second shaft 50 are concentric and rotate via bearing systems 38 about the engine central axis A which is collinear with their longitudinal axes.

The core airflow is compressed by the first compressor 44 then the second compressor 52, mixed and burned with fuel in the annular combustor 56, then expanded over the second turbine 54 and first turbine 46. The first turbine 46 and the second turbine 54 rotationally drive, respectively, the first spool 30 and the second spool 32 in response to the expansion.

The engine 20 is a high-bypass geared aircraft engine that has a bypass ratio that is greater than about six (6), with an example embodiment being greater than ten (10), the gear assembly of the fan drive gear system 48 is an epicyclic gear train, such as a planetary gear system or other gear system, with a gear reduction ratio of greater than about 2.3:1 and the first turbine 46 has a pressure ratio that is greater than about five (5). The first turbine 46 pressure ratio is pressure measured prior to inlet of first turbine 46 as related to the pressure at the outlet of the first turbine 46 prior to an exhaust nozzle. The first turbine 46 has a maximum rotor diameter and the fan 42 has a fan diameter such that a ratio of the maximum rotor diameter divided by the fan diameter is less than 0.6. It should be understood, however, that the above parameters are only exemplary.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft, with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram °R)/(518.7° R)]^{0.5}. The “Low corrected fan tip speed” as disclosed herein according to one non-limiting embodiment is less than about 1150 ft/second.

As can be appreciated, the engine 20 can include a variety of different components that utilize a cooling fluid for internal cooling, such as relatively cool air from the compressor section 24. FIG. 2 illustrates an example of one such component 60. In this example, the component 60 is a turbine blade of the turbine section 28. It is to be understood, however, that the examples herein are not limited to blades or airfoils and can also be applied to blade outer air seals, combustor liners, case structures, or other components that utilize dedicated internal cooling, for example.

In this example, the component 60 has a body 62 that defines an external and internal shape with respect to internal passages. In this example, the body 62 includes an airfoil section 64, a platform 66 and a root 68. The airfoil section 64 extends outwardly from the platform 66 and the root 68 extends outwardly in an opposed direction from the platform 66.

The body 62 defines an internal micro-channel, a portion of which is schematically shown at 70 (hereafter “channel 70”). For example, the channel 70 can be a channel in an engineered vascular cooling structure, such as the engineered vascular cooling structure disclosed in co-pending application Ser. No. 61/757,441 entitled GAS TURBINE ENGINE COMPONENT HAVING ENGINEERED VASCULAR STRUCTURE (Attorney Docket 67097-2450 PRV; PA-25701-US) incorporated by reference in its entirety, but is not limited to such structures.

FIG. 3 illustrates a magnified, isolated view of the channel 70. For the purpose of description, only the surfaces defining the channel 70 are shown. It is to be understood however, that the channel 70 can extend through a wall of the body 62, such as an internal or external wall. Furthermore, although the channel 70 is depicted in FIG. 2 as being located in the airfoil section 64, the channel 70 can alternatively be located in the platform 66 or root 68, or can span between two or more of the airfoil section 64, platform 66 and root 68.

Referring to FIG. 3, the channel 70 extends in a lengthwise direction along a reference line L between a first reference position, P₁, along the reference line L and a second reference position, P₂, along the reference line L. Although the channel 70 extends generally linearly in the lengthwise direction in the example, the channel 70 can alternatively be non-linear, in which case the reference line L would be non-linear. In one example, the reference line L, and thus the channel 70 can follow (i.e., run parallel to) an exterior surface of the component 60, such as but not limited to a hot gas path surface. As shown and indicated at 72, the channel 70 twists with respect to the reference line between the first reference position P₁ and the second reference position P₂. In this example, the channel 70 twists several full rotations around the reference line L along the length of the channel 70 between reference position P₁ and reference position P₂. With respect to an intermediate reference position, P₃, the channel 70 twists approximately 180° around the reference line L.

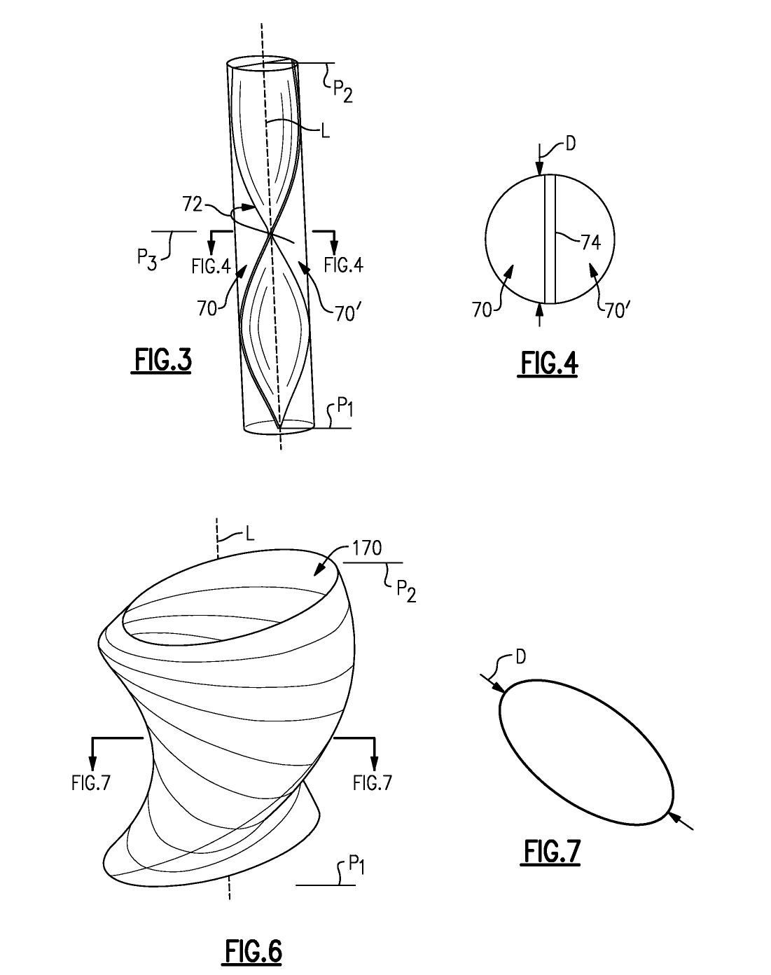

FIG. 4 shows a sectioned view of the channel 70 taken along a plane that is perpendicular to the reference line L. In this example, the channel 70 has a maximum dimension, D, in the illustrated cross-section. In one example, the maximum dimension D is less than 0.635 millimeters. In another embodiment, the channel 70 has a maximum diameter of less than 0.5 millimeters. In yet another embodiment, a maximum diameter of the channel 70 is less than 0.25 millimeters. The relatively small dimensioned channel 70 can also be referred to as a vascular channel. Additionally, the channel 70 can be embedded in a wall that has a thickness of about 0.635 millimeters to about 4.0 millimeters. The channel 70 twists by a twist amount of at least 180° with respect to the reference line L and is, according to this disclosure, a micro-channel. In other examples, the maximum dimension D is smaller, such as less than 0.5 millimeters or less than 0.25 millimeters.

The combination of the twist amount and the micro-size of the channel 70 serves to produce a desired type of swirling flow of a cooling fluid through the channel 70. The swirling flow has a swirl vector that is parallel to the reference line L. For example, FIG. 5 schematically illustrates the reference line L and the swirl vector, indicated at V, of the swirling flow the cooling fluid as it flows through the channel 70. The swirl vector V that is parallel to the reference line L enhances the cooling effect in the component 60. For example, the swirl vector V increases a co-efficient of heat transfer between the cooling fluid and the body 62 of the component 60. Thus, the disclosed twist amount and maximum dimension D provide enhanced cooling capability in the component 60.

In the illustrated example, the component 60 also includes an additional internal micro-channel 70′ (FIG. 4) that also twists around the reference line L. Here, the additional channel 70′ is symmetrically arranged to the channel 70 with respect to the reference line L. That is, each point on the surfaces bounding the channel 70 has a corresponding symmetric point on the surfaces bounding the additional channel 70′ such that the two symmetric points are equidistant from the reference line and can be connected by an axis that intersects the reference line L. Due to manufacturing tolerances, the equidistance of the two symmetric points and the axis can vary by less than 10%, less than 5% or less than 1%, for example.

In this example, a common divider wall 74 separates the channels 70/70′ in the lengthwise direction of the channels 70/70′ along the reference line L. The divider wall 74 twists in a helical manner such that each of the channels 70/70′ helically twists around the reference line L. Further, each of the channels 70/70′ in this example is semi-circular such that, together, the channels 70/70′ form a circular passage. The thickness of the common divider wall 74 can be selected based upon the fabrication capability of the fabrication technique used to make the component 60, such as additive manufacturing.

FIG. 6 illustrates another example internal micro-channel 170 that can also or alternatively be used in the component 60. In this disclosure, like reference numerals designate like elements where appropriate and reference numerals with the addition of one-hundred or multiples thereof designate modified elements that are understood to incorporate the same features and benefits of the corresponding elements. Here, the channel 170 has an elliptical cross-sectional shape, as shown in the sectioned view in FIG. 7. Similar to the channel 70, the channel 170 twists at least 180° with respect to the reference line L between a first reference position P₁ and a second reference position P₂. The cross-section of the channel 170 also has a maximum dimension, D, such that the twist amount and the maximum dimension D produce swirling flow of a cooling fluid through the channel 170 with a swirl vector that is parallel to the reference line L. Whereas the channel 70 twists around the reference line L but does not intersect the reference line L, the channel 170 twists about the reference line L and intersects the reference line. That is, the twist in channel 170 can be represented by angular orientations of the oval cross-sections of the channel along the reference line L. For example, the long axis of the oval cross-sections rotates as a function of position along the reference line L. The channel 170 provides a relatively more open passage and thus can be more tolerant to particles that may be entrained in the cooling fluid.

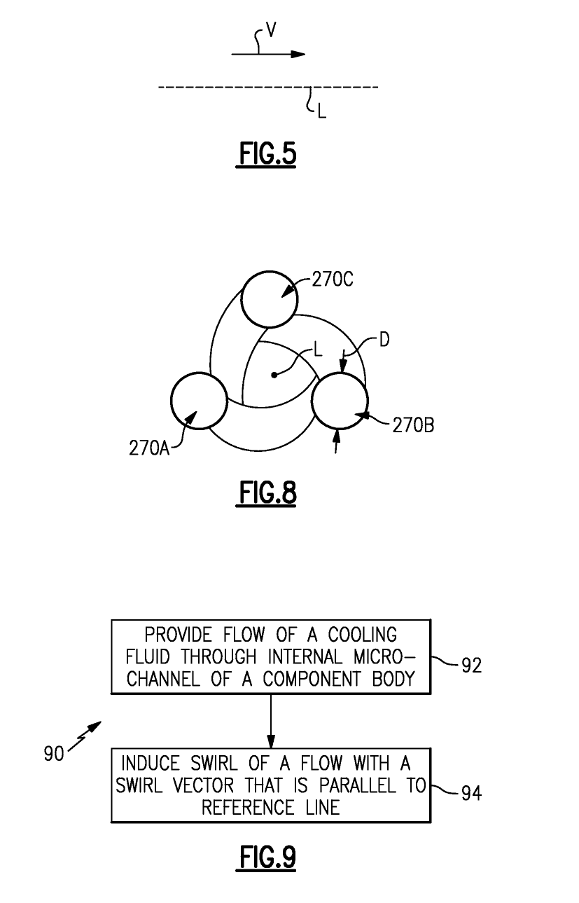

FIG. 8 shows another example of internal micro-channels 270a/270b/270c that twist at least 180° with respect to a reference line L (extending perpendicular to the plane of the illustration). In this example, each of the channels 270a/270b/270c is similar to the channel 70 or 70′ of FIG. 3 but is circular in cross-section. Further, at a plane that is perpendicular to the reference line L, the centerpoints of the cross-sections of the channels 270a/270b/270c are circumferentially arranged around the reference line L. For example, each respective centerpoint is circumferentially offset from the other of the channels 270A/270B/270C by about 120°.

The geometries disclosed herein may be difficult to form using conventional casting technologies. The component 60 and internal micro-channels 70, 70′, 170, 270a, 270b or 270c can be produced using an additive manufacturing process, such as direct metal laser sintering (DMLS), electron beam melting (EBM), selective laser sintering (SLS) or selective laser melting (SLM). In additive manufacturing, a powdered metal suitable for the end use is fed to a machine, which may provide a vacuum, for example. The machine deposits multiple layers of powdered metal onto one another. The layers are selectively joined to one another with reference to Computer-Aided Design data to form solid structures that relate to a particular cross-section of the component 60. In one example, the powdered metal is selectively melted using energy beam. Other layers or portions of layers corresponding to negative features, such as cavities or openings, are not joined and thus remain as a powdered metal. The unjoined powder metal may later be removed using blown air, for example. With the layers built upon one another and joined to one another cross-section by cross-section, the component 60 or a portion thereof, such as for a repair, with any or all of the above-described geometries, may be produced. The component 60 can be post-processed to provide desired structural characteristics. For example, the component 60 may be heated to reconfigure the joined layers into a desired crystalline structure.

The geometries disclosed herein, or other geometries according to this disclosure, can be produced using generator operators. The generator operator is a technique of producing the twist based on a selected cross-sectional geometry. Using the elliptical shape of the channel 170 as an example, the design of the channel 170 is a design sequence that incrementally defines the surfaces of the channel 170. In such as sequence, an initial ellipse of desired size is defined. A second, identically-sized ellipse is defined an incremental distance from the initial ellipse along the reference line L, The second ellipse is rotated by an incremental amount. A third ellipse is defined an incremental distance from the second ellipse and is rotated an incremental amount from the second ellipse. This sequence can be repeated such that a surface bounding the ellipses defines the channel 170. As can be appreciated, a similar sequence can be used for other geometric cross-sections. Likewise, the common divider wall 74 can serve as the feature that is incrementally changed to produce the channels 70/70′. Additionally, the incremental cross-sections can be translated laterally with respect to the reference line L to generate geometries such as that shown in FIG. 8. It is to be understood however, that the geometries disclosed herein are not limited to generation by the generator operator technique.

FIG. 9 illustrates a method 90 of managing cooling in a gas turbine engine component, such as component 60. At step 92, the method 90 includes providing a flow of a cooling fluid through an internal micro-channel 70, 70′, 170, 270a, 270b or 270c. At step 94, a swirl of a flow of the cooling fluid is induced in the internal micro-channel 70, 70′, 170, 270a, 270b or 270c with the swirl vector V that is parallel to the reference line L. The swirl vector V is induced by the combination of the twisting with respect to the reference line L and the maximum dimension D, as described above. The twist amount and the maximum dimension D work in combination to induce the swirl with the swirl vector V that is parallel to the reference line L. That is, a suitable amount of twist and a relatively small channel size is needed to produce the swirl vector ZV that is parallel to the reference line L. In larger channels, the cooling fluid can flow axially down the channel without inducement of swirl with a swirl vector that is parallel to the axial direction of the channel and, likewise, relatively small amounts of twist are not sufficient to produce or maintain swirl.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A gas turbine engine component comprising:
a component body defining an internal micro-channel extending in a lengthwise direction along a reference line, the internal micro-channel extending between a first reference position along the reference line and a second reference position along the reference line, the internal micro-channel twisting at least 180° with respect to the reference line between the first reference position and the second reference position.

2. The gas turbine engine component as recited in claim 1, wherein the internal micro-channel twists at least 360° with respect to the reference line between the first reference position and the second reference position.

3. The gas turbine engine component as recited in claim 1, wherein the internal micro-channel twists multiple full revolutions with respect to the reference line.

4. The gas turbine engine component as recited in claim 1, further including at least one additional internal micro-channel also twisting at least 180° with respect to the reference line between the first reference position and the second reference position.

5. The gas turbine engine component as recited in claim 1, further including at least one additional internal micro-channel that is symmetrically arranged to the internal micro-channel with respect to the reference line.

6. The gas turbine engine component as recited in claim 1, wherein the internal micro-channel is helical.

7. The gas turbine engine component as recited in claim 1, further including a plurality of additional internal micro-channels that also twist with respect to the reference line between the first reference position and the second reference position.

8. The gas turbine engine component as recited in claim 1, wherein a cross-section of the internal micro-channel taken between the first reference position and the second reference position is elliptical.

9. The gas turbine engine component as recited in claim 1, wherein a cross-section of the internal micro-channel taken between the first reference position and the second reference position is semi-circular.

10. The gas turbine engine component as recited in claim 1, wherein the internal micro-channel has a maximum dimension in a cross-section taken perpendicular to the reference line of less than 0.635 millimeters.

11. The gas turbine engine component as recited in claim 1, wherein the component body is metallic.

12. A gas turbine engine component comprising:
a component body defining an internal channel extending in a lengthwise direction along a reference line, the internal channel extending between a first reference position along the reference line and a second reference position along the reference line, the internal channel twisting, by a twist amount in degrees, with respect to the reference line between the first reference position and the second reference position, the internal channel having a maximum dimension in a cross-section taken perpendicular to the reference line, the twist amount and the maximum dimension producing a swirl of a flow of a cooling fluid through the internal channel with a swirl vector that is parallel to the reference line.

13. The gas turbine engine component as recited in claim 12, wherein the twist amount is at least 360° and the maximum dimension is less than 0.635 millimeters.

14. The gas turbine engine component as recited in claim 12, wherein the twist amount is greater than 360° and the maximum dimension is less than 0.635 millimeters.

15. The gas turbine engine component as recited in claim 12, wherein the cross-section is semi-circular or elliptical.

16. A method of managing cooling in a gas turbine engine component, the method comprising:
providing a flow of a cooling fluid through an internal micro-channel of a component body, the internal micro-channel extending in a lengthwise direction along a reference line; and
inducing a swirl of a flow of a cooling fluid through the internal micro-channel with a swirl vector that is parallel to the reference line.

17. The method as recited in claim 16, including inducing the swirl using:
a) a twisting of the internal micro-channel of at least 360° with respect to the reference line between a first reference position along the reference line and a second reference position along the reference line, and
b) a maximum dimension of less than 0.635 millimeters in a cross-section taken perpendicular to the reference line.

18. The method as recited in claim 17, including selecting the twisting of the internal micro-channel of at least 360° with respect to the reference line and selecting the maximum dimension of less than 0.635 millimeters to increase a heat transfer coefficient of the internal micro-channel.
